(19) United States
(12) Patent Application Publication
(10) Pub. No.: US 2005/0226400 A1
(43) Pub. Date: Oct. 13, 2005

(54) System and method for a telecommunications network

(76) Inventors: Norman Farber, Freehold, NJ (US); Casem Majd, Holmdel, NJ (US); Paramasiviah Harshavardhana, Marlboro, NJ (US); Weiping Wang, Holmdel, NJ (US)

Correspondence Address: DOCKET CLERK, P.O. BOX 802432, DALLAS, TX, 75380, US

(21) Appl. No.: 11/054,965

(22) Filed: Feb. 10, 2005

Related U.S. Application Data
(60) Provisional application No. 60/557,153, filed on Mar. 25, 2004.

(51) Int. Cl. H04M 15/00; H04M 3/42

(52) U.S. Cl. 379/114.01; 379/127.01; 379/133; 379/112.01

(57) ABSTRACT

A method for improving traffic flow over a first network by adjusting the ratio and identity of traffic offloaded to a second network based on analysis of call detail records (CDRs).

### CROSS-REFERENCE TO OTHER APPLICATION

This application claims priority from U.S. Provisional Patent Application 60/557,153, filed Mar. 25, 2004, which is hereby incorporated by reference.

### TECHNICAL FIELD OF THE INVENTION

This disclosure relates generally to the planning and operation of a communication network and, more particularly, relates to products, systems, and methods for optimally routing traffic and minimizing network cost, based on analysis of call data records.

### BACKGROUND OF THE INVENTION

Mobile telephone systems include a variety of services and functions beyond simple direct voice communication. Text messages, multimedia messages, internet access, and paging services are widely available on modern mobile communication systems. Many cellular telephone operators provide these advanced services by breaking the transmissions into small pieces known as “packets.” A packet generally also includes information needed by the recipient to reassemble the pieces in the correct order. The process of breaking a message into small pieces and labeling them for reassembly is known as “packetizing” the data.

FIG. 1 shows a known telecommunications system. A telephone 110 is typically connected to the Local Exchange (LE) Switch 120 of the Public Switched Telephone Network (PSTN) by a copper wire connection known as the Local Loop. The Local Exchange Switch is operated by a local telephone service provider known as the Local Exchange Carrier (LEC).

When a caller makes a telephone call, the caller's voice is converted to an electrical signal by the telephone 110. The electrical signal travels from the telephone onto the Local Loop and then to the Local Exchange Switch 120. If the call is a long-distance call, the Local Exchange may pass the electrical signal to a long-distance network 130 also known as a long-distance “trunk” or “backbone”. The long-distance trunk 130 serves as an interconnection between Local Exchange networks such as LEC 120 and LEC 140. A typical long-distance telephone call is routed from the caller's phone (the “originating phone”) 110 to the called phone (known as the “terminating phone” or “termination point”) 150 by passing through several networks. The originating local telephone service provider (also known as a local exchange carrier or “LEC”) passes the call to a long-distance service provider. The long-distance provider then sends the call over a backbone to the terminating LEC Switch 140. The terminating LEC passes the call over the local loop to the called party telephone 150.

A LEC generally must pay a “termination fee” or “interconnection fee” to another network operator for the privilege of sending a phone call or data onto the other operator's network. In the United States, prior to the breakup of the Bell telephone companies, it was common for a long-distance phone call to travel from the caller to the called party over networks owned by the same company. For example, the LEC and the long-distance provider may have both been owned by AT&T Corporation. Today, however, the LECs and the long-distance companies are separate corporations. Thus, during the typical “caller pays” variety of long-distance phone call, the originating LEC generally pays a termination fee to the long-distance carrier. The long-distance carrier, in turn, pays a portion of that fee to the terminating LEC so that the call can pass over its network.

After most calls originate, the network creates a Call Detail Record (CDR, also referred to as a call data record) so that the appropriate party can be billed for the cost of the call. The CDR may contain information such as date, time call was placed, duration of the call, whether the call was incoming (terminating) or outgoing (originating), terminating status (e.g., busy, no answer), etc. Many sorts of networks such as the Integrated Services Digital Networks (ISDN), the PSTN, Private Branch Exchange (PBX), cellular networks, satellite telephony networks, and paging networks, use Call Data Records for customer billing. Even some Internet Service Providers use records similar to a CDR. At the end of the billing period, the Call Detail Records for a customer are summed up and a bill for the appropriate amount is sent to the customer. Call Detail Records are sometimes referred to as Event Data Records or Transaction Data Records. Some CDRs may record the path of the message through the network in addition to other parameters such as call duration, time of call, originating party, or terminating party.

Some businesses have a Private Branch Exchange (PBX) that connects their telephones to the Local Exchange. Due to deregulation of the telephone networks, many LECs can use the same Local Exchange. Each LEC might provide a different per minute rate to the business. Due in part to the different interconnect fees between the network operators, the rates also will vary depending upon the termination point of the call. Some PBX have special software that correlates the dialed number to a lookup table of carriers/rates and selects the lowest cost LEC for that particular phone call. This special PBX software is known as Least Cost Routing (“LCR”) software. A PBX with LCR software is helpful for allowing a customer to choose between different LECs but it does not help the LEC plan its network or determine how to route the call once it has been switched to the LEC.

However, designing and operating a network in a way that reduces payments to other network operators while maintaining acceptable quality of service is a dilemma that continues to confound network operators. Due to the complexity of modern communication networks, it is quite difficult to design and operate a communication network that can efficiently route network traffic, especially via a combination of local and long-distance networks. A known, but suboptimal, solution has been to purchase enough bandwidth on the long-distance network to handle the maximum traffic during peak calling times.

There is a need for a system, method, and products that overcome the above problems, as well as providing additional benefits.

### SUMMARY OF THE INVENTION

The present invention overcomes the limitations of the prior art and provides additional benefits. A brief summary of some embodiments and aspects of the invention are first presented. Some simplifications and omissions may be made in the following summary. The summary is intended to highlight and introduce some aspects of the disclosed embodiments, but not to limit the scope of the invention. The summary does not provide an exhaustive list of embodiments of the invention.

A detailed description of illustrated embodiments is presented after the summary. The detailed description will permit one skilled in the relevant art to make and use aspects of the invention. One skilled in the relevant art can obtain a full appreciation of aspects of the invention from the subsequent detailed description, read together with the Figures, and from the claims (which follow the detailed description).

One embodiment of the invention comprises an integrated method for reducing the cost of handling wireless long-distance traffic using a combination of owned/leased voice-over-IP (VoIP) backbone capacity and minute-of-use-based overflow to a long-distance provider, integrating both circuit-based performance criteria (e.g, call setup, blocking) and IP-based performance criteria (e.g, call setup, delay, jitter, packet loss) to meet specified end-to-end Quality of Service (QoS) objectives.

Another embodiment of the invention comprises a method for reducing the cost of handling wireless long-distance traffic using a combination of owned/leased backbone capacity and minute-of-use-based overflow to a long-distance provider, while meeting end-to-end performance criteria.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 shows a block diagram of a prior art method of offloading calls from the Local Exchange to a Long Distance Carrier.

FIG. 2 depicts a block diagram of a communication network according to an embodiment of the invention.

FIG. 3 shows a simplified VoIP network.

FIG. 4 depicts a Call Detail Record load projection table for the simplified VoIP network shown in FIG. 3.

FIG. 5 shows a table including the terminating offered and carried load between Media Gateway A and Media Gateway B in the simplified VoIP network of FIG. 3.

FIG. 6 shows a more complex VoIP network, in accordance with an embodiment of the present invention.

FIGS. 7A, 7B, and 7C show a flow diagram of an embodiment of the disclosed invention.

FIG. 8 shows a method of calculating savings due to buying/leasing a new backbone.

In the drawings, the same reference numbers and acronyms identify elements or acts with the same or similar functionality for ease of understanding and convenience. To easily identify the discussion of any particular element or act, the most significant digit or digits in a reference number refer to the Figure number in which that element is first introduced (e.g., element 1104 is first introduced and discussed with respect to FIG. 11).

Figure numbers followed by the letters “A,” “B,” “C,” etc. indicate either (1) that two or more Figures together form a complete Figure (e.g., FIGS. 10A and 10B together form a single, complete FIG. 10), but are split between two or more Figures because of paper size restrictions, amount of viewable area within a computer screen window, etc., or (2) that two or more Figures represent alternative embodiments or methods under aspects of the invention.

### DETAILED DESCRIPTION OF THE INVENTION

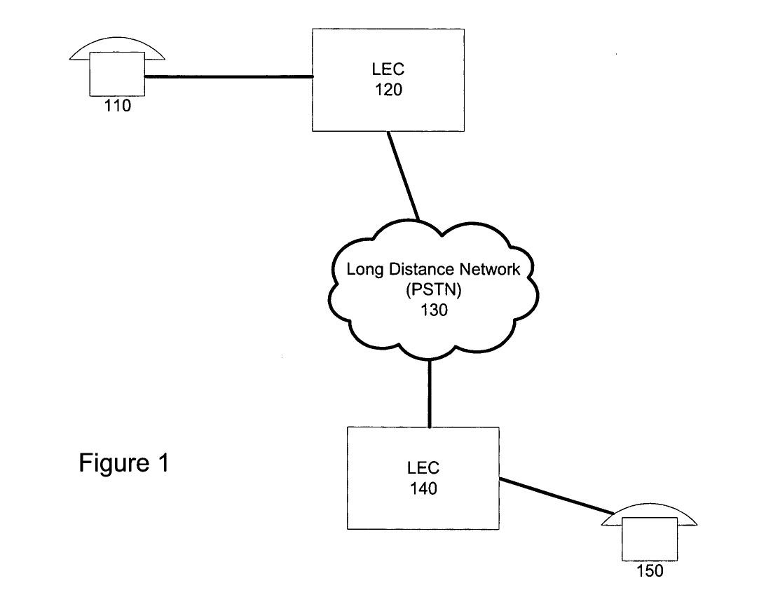

FIGS. 1 through 8, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

The following description provides specific details for a thorough understanding of, and enabling description for, these embodiments of the invention. However, one skilled in the art will understand that the invention may be practiced without these details. In other instances, well known structures and functions have not been shown or described in detail to avoid unnecessarily obscuring the description of the embodiments of the invention.

Definitions: In general, brief definitions of several terms used herein are preceded by the term being enclosed within double quotation marks. Such definitions, although brief, will help those skilled in the relevant art to more fully appreciate aspects of the invention based on the detailed description provided herein. Such definitions are further defined by the description of the invention as a whole (including the claims) and not simply by such definitions.

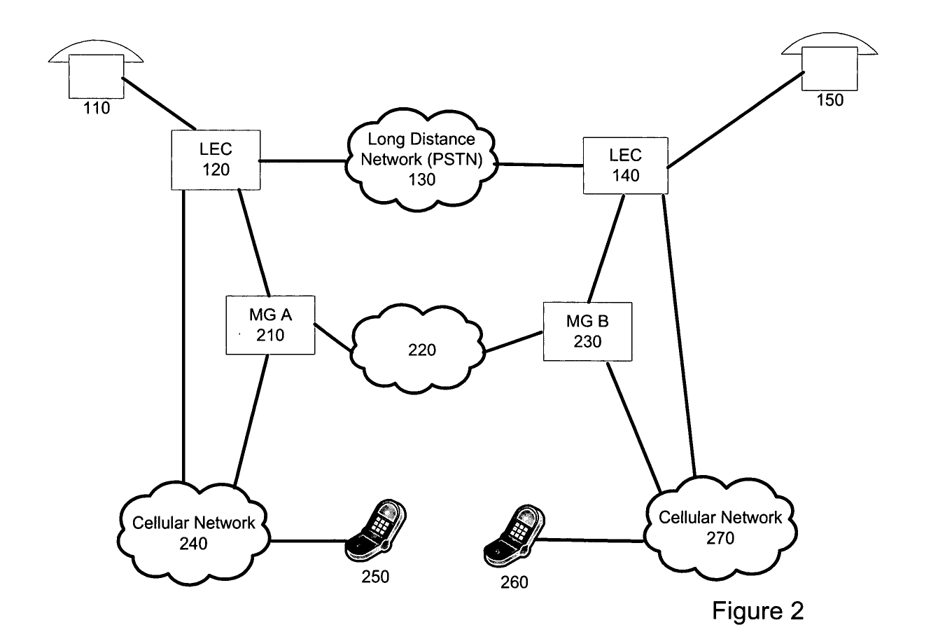

FIG. 2 shows a communication network according to one embodiment of the disclosed invention. Telephones 110, 150 are connected to LEC switches 120, 140. The LEC switches 120, 140 are interconnected by one or more long distance networks 130-1, 130-2, etc. LEC switch 120 is also connected to Media Gateway A (“MGA”) 210 and cellular network 240. LEC switch 140 is also connected to Media Gateway B (“MGB”) 230 and cellular network 270. MGA 210 and MGB 230 are interconnected by a packet-switched network 220. Mobile communication device 250 is wirelessly connected to cellular network 240 which is then connected either directly to Media Gateway 210 or via an intermediate mobile switch 240-S. Mobile communication device 260 is wirelessly connected to cellular network 270 which is then connected either directly to Media Gateway 230 or via an intermediate mobile switch 270-S . Note that the various carriers illustrated in the embodiment need not all be different corporations. That is, one corporation might own LEC switch 120, another might own cellular network 240 and Media Gateway 210 and long-distance network 130-1, another might own LEC switch 140, etc. Ownership of various components does not affect the problems being addressed by the embodiment but does affect whether termination charges are involved when a call passes from one carrier to another.

MGA 210 and MGB 230 may be mobile switches (switches that originate and terminate traffic from mobile cell sites) or they may be tandem switches (switches that originate and terminate traffic from mobile switches). Further, they may be Soft Switches. “Soft Switch” is a generic term for next generation software-controlled switches, however, one skilled in the art understands any suitable switch, such as Class 4 or Class 5 switches, could be an acceptable substitute. Substitution of SS7 switches for Soft Switches may require slight modifications to the algorithms but the algorithm steps remain valid regardless of the infrastructure. Soft Switches are known to be manufactured by companies such as Sonus and Siemens.

The cellular telephone industry is useful as an example of a system that can benefit from embodiments of the current invention. In a typical cellular system, the cellular service provider has the option of transferring long distance calls to a long distance telephone company. When a subscriber dials a long distance number, the call is first routed locally through the cellular network and onto the local exchange. From the local exchange, the call is then put on the long distance company's network. When the call is near its termination point (the phone corresponding to the dialed number), the call is transferred from the long distance network to the local exchange.

Whenever a call is transferred from the cellular operator's network onto a network owned by another company, the cellular operator must pay a termination tariff to the other company. For example, assume a cellular customer places a long distance call from Texas to New York. Typical termination tariffs might be: one cent per minute (1¢/minute) if the call is handed over to a long distance carrier in Texas, or one-tenth cent per minute (0.1¢/minute) if the call is carried by the cellular network provider to New York and then passed to the local exchange in New York.

A mobile to mobile call would incur no termination expenses if the entire call is routed and terminated on the same cellular network. However, even a mobile to mobile call within a given cellular company will incur termination tariffs if the call must be passed to a long distance carrier at some point. For example, if a mobile telephone in Texas calls a mobile telephone in New York, it is possible that the call will be routed from the Texas branch of the cellular company onto a long distance operator's network and then onto the New York branch of the cellular company. The mobile operator would have to pay a termination tariff for the middle portion of the connection, the long distance backbone.

Wireless carriers have two choices when their customers dial a number that requires long-distance handling: (1) carry the call all of the way on their own network or (2) carry the call part of the way on their own network and hand the call off at some point to a long-distance carrier. The most efficient arrangement is typically a mixture of both, but optimizing that mixture while meeting all performance criteria requires careful analysis, especially when the wireless carrier's backbone network is IP-based while some or all of the originating network, the terminating network, and the long-distance carrier's network are circuit-based. An embodiment of this invention defines a process that integrates the circuit-based and IP-based load and performance calculations and optimizes the cost of the resulting hybrid network that meets all performance criteria. The process also produces the mobile switch and/or Media Gateway routing matrices that yield an improved solution

It is common for cellular service providers to enter into Minute of Use (MOU) agreements with long distance providers. In return for purchasing in advance a certain number of minutes of long distance, the long distance company guarantees the cellular service provider that it will reserve enough bandwidth on its trunks to handle the calls transferred from the cellular operator. As an example, a cellular operator, such as AT&T Wireless Services, may contract with a long distance provider, such as AT&T Corporation or MCI, for ten million (10,000,000) minutes of long distance per month.

Most cost-effective networks must offload some call traffic to other networks at peak usage times or lose the attendant revenue (while incurring customer dissatisfaction). Typically, a network is designed to carry very close to 100% of its estimated monthly traffic. This initial network design will entail a certain capital cost to build. Traffic on the network, however, will have peaks and valleys such that it is not evenly distributed. A network designed to handle only the average traffic flow will be overwhelmed by traffic flow at peak calling hours and will not carry anywhere near 100% of its monthly traffic. On the other hand, the network could be built to handle the peak traffic, rather than the average traffic. This network will carry close to 100% of its monthly traffic, but the cost will be prohibitive because the extra capacity required to capture peak load periods will be unused during the off-peak time, which delays the recovery of the network operator's initial investment to build the network.

By using an embodiment of the disclosed invention, the cellular company can better balance the percentage of traffic that it carries on its own facilities (capital) vs. the percentage that is hands off to long-distance carriers on a per minute-of-use basis.

The routing algorithm may vary depending on the type of transport network that is used to offload traffic from the long distance carrier. For example, the algorithm for a packet-switched VoIP backbone may be different than the algorithm for a circuit-switched backbone. Also, the algorithm for a packet-switched VoIP backbone may vary depending on which version of VoIP protocol is used. Two common VoIP protocols are the Session Initiation Protocol (SIP) and the H.323 protocol. The balancing of traffic on multiple networks, while maximizing cost flexibility, introduces potential performance issues. This is especially true if the cellular company in the embodiment above chooses to interconnect several of its Media Gateways via an IP backbone as means of carrying its long distance traffic either part-way or all the way to its termination point. Calls carried on a LEC or long-distance carrier's network, traditionally circuit-based networks, are subject to blocking constraints during peak periods of congestion. Calls carried on an IP backbone network are subject to packet-loss constraints during peak periods of congestion. Calls carried on both types of networks are subject to both types of constraints. Creating performance-comparable cost comparisons becomes a thorny problem that the embodiment addresses directly.

In all embodiments of this invention, Call Detail Record (CDR) analysis is used to estimate the volumes of traffic to various long-distance terminations for the purpose of comparing the monthly cost of handing off those minutes to a given long-distance carrier. CDRs have traditionally been used for the purpose of billing the subscriber for use of the communication network. As the number of nodes (gateways, switches, etc.) in the network expands, the problem of determining an exact solution for optimal traffic routing quickly becomes intractable. In fact, optimal traffic routing may be an NP-Complete problem that is only susceptible to exact solution by brute force attacks. Although a general method for determining exact solutions for NP-complete problems is not currently known, and may be mathematically impossible, the network operator can determine certain heuristic solutions by analyzing the CDRs. Using these rules of thumb, the operator can determine which traffic should be offloaded to another network, which can be handled more cheaply on the operator's own dedicated transport network, or whether to use alternate long distance carriers to increase congestion performance (leading to increased availability, avoidance of packet loss and higher revenues).

A exemplary method to carry out one embodiment of the present invention might extract call traffic information from the CDR data; eliminate erroneous data; create hourly point-to-point traffic load data; identify where to build/lease dedicated transport facilities based on those load data; optimize traffic hand-off between the upgraded network (i.e., with dedicated transport facilities based on the previous analysis) and other PSTN carriers; and engineer the trunks to maintain and assure the desired performance level. For example, a cellular operator could determine where it should lease or build trunks (such as OC-3/STM-1, etc., fiber optic cables) between network nodes instead of paying MOU tariffs to other carriers.

A VoIP dedicated transport facility is an example of one sort of special case of backbone trunk. An exemplary method to carry out one embodiment of the present invention includes determining the wireless Switch-to-Switch Offered Load in Erlangs; determining the Media Gateway to Media Gateway (MG) available IP bandwidth in Mega-bits-per second (Mbps); determining the trunk-group size for each terminating switch (typically in T1 units); calculating the traffic to be carried between Media Gateways; calculating the traffic to be off-loaded between switches; re-evaluating the MG-to-MG carried load; re-evaluating the switch-to-MG carried load; and adding back load where capacity on the IP backbone is available.

The presently preferred embodiment of the invention uses CDR analysis to find out which long-distance call terminations are most expensive for a given carrier. To the extent practicable, the most expensive long distance calls are put on the carrier's dedicated transport network to try to maximize termination savings. Excess load will be handed off to alternate long distance carriers (e.g. PSTN), which are used as back-up to increase performance and availability while avoiding overbuild of the carrier's dedicated network.

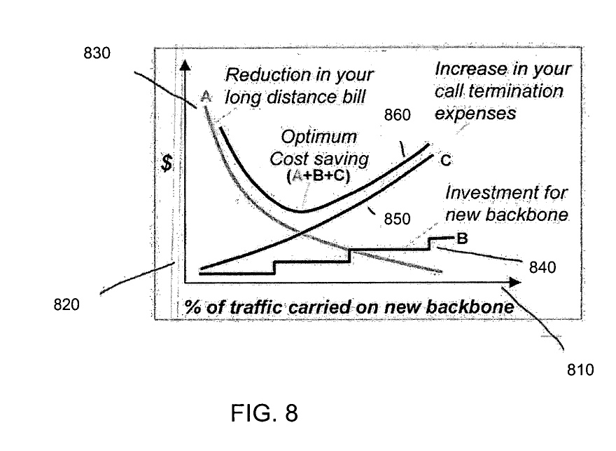

FIG. 8 depicts the trade-offs involved in minimizing the overall cost of carrying long distance calls. The horizontal axis 810 shows percentage of traffic carried on the new backbone. The vertical axis 820 reflects monetary cost. As can be seen in curve 830, long distance payments to PSTN operators decrease as more traffic is off-loaded to a wireless carrier's dedicated/owned backbone. However, curve 850 shows that the wireless carrier's own call termination expenses will rise as more traffic passes over its network. Curve 840 shows that the investment for a new backbone increases in proportion to the backbone's ability to carry more traffic. Curve 860 shows that the reduction in long distance payments of 830 is offset by the costs of building/leasing a dedicated backbone of 840 and increases in the wireless carrier's own termination costs of 850.

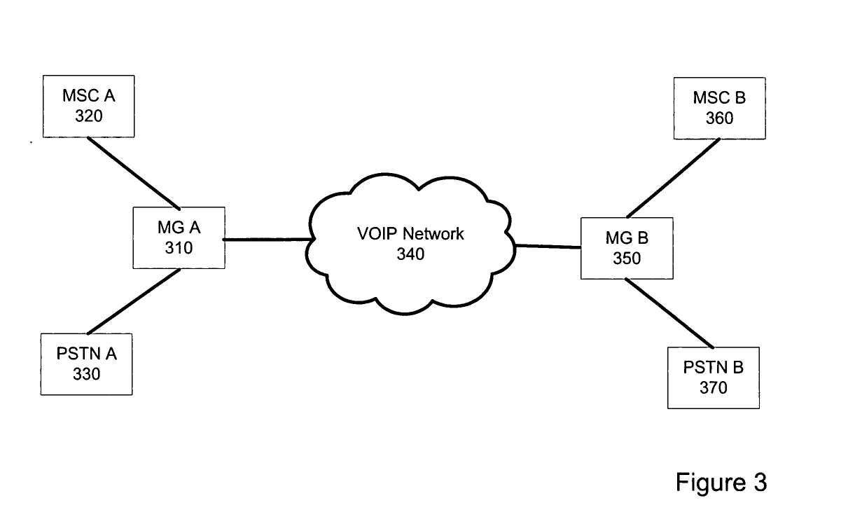

Embodiments of the invention will be illustrated by means of several simple network examples. FIG. 3 shows a simple network. MGA 310 is connected to Mobile Switching Center A (“MSCA”) 320 and Mobile Switching Center B (“MSCB”) 330. A Mobile Switching Center is a switching device in a cellular network. MGB 340 is connected to Mobile Switching Center C (“MSCC”) 350 and Mobile Switching center D (“MSCD”) 360. MGA 310 and MGB 340 are interconnected by Public Switched Telephone Network A (“PSTNA”) 370 and VoIP Network 380. The terms and definitions used in the detailed algorithm description will be defined in these examples.

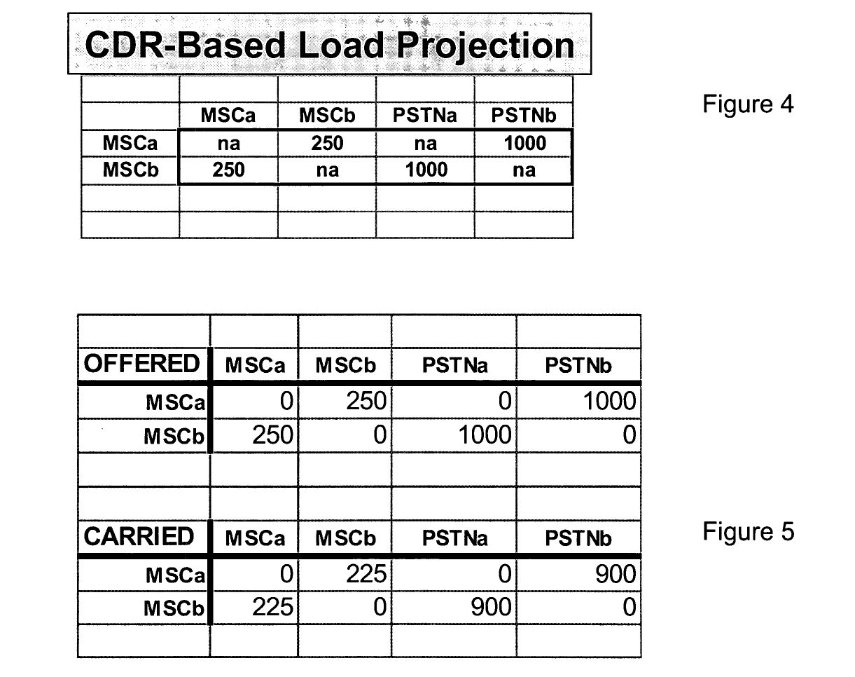

FIG. 4 shows an exemplary table of CDR-based Load Projections betweens MSCs. The load between MSCA and MSCC is 2500 Erlangs. The load is proportional to the number of simultaneous calls that can be in progress between MSCA and MSCC and is therefore called the offered load. Simalarly, the load between MSCA and MSCD is 1000 Erlangs, the load between MSCB and MSCD is 1000 Erlangs, and the load between MSCB and MSCC is 2500 Erlangs. Once network blocking is taken into account, the offered load gets translated into carried load. The carried load represents the average number of simultaneous calls in progress. A terminating Busy Hour (BH) blocking equal to 10% is assumed for ease of explanation. With this blocking assumption, 10% of all the offered calls are blocked and hence only 90% of the calls are actually carried. Thus the Carried Load between MSCA and MSCC is 2250 Erlangs. The Carried Load between MSCA and MSCD is 900. The Carried Load between MSCB and MSCD is 900. The carried load between MSCB and MSCC is 2250. FIG. 5 shows the carried load between the different MSCs. According to FIG. 5, the MSCA to MSCC average calls in progress is 2,250.

With respect to IP performance, the critical paramater is the maximum number of calls in progress, which can be approximated from the average in various ways. Approximating the maximum calls in progress for our example as 2,400 and assuming 100 Kilo bits per second (“Kbps”) per voice call (taking into account QoSpacket loss and IP header requirements), the maximum “bits in progress” would be 240 Megabits bits per second (“Mbps). This is the bandwidth required on the MGA to MGB VoIP link to carry the maximum number of calls in progress traffic from MSCA to MSCC without loss of packets. If the same calculation is applied to the traffic from MSCB to MSCC, it is clear that an additional 240 Mbps of bandwidth would be needed on the MGA to MGB VoIP link. For the traffic from MSCA to MSCD, assuming that the maximum number of calls in progress is 950, an additional 95 Mbps of bandwidth would be needed on the MGA to MGB link. If a similar calculation is performed for the traffic between MSCB and MSCD, it can be seen that the MGA to MGB link requires a further 95 Mbps. Thus, in order to carry the entire traffic between the MSCs, the MGA to MGB VoIP link would need a total bandwidth of 670 Mbps without losing packets. This bandwidth needed to carry the traffic is generally referred to as the minimum bit rate needed for the link. Assuming that only 630 Mbps of bandwidth is actually available on the MGA to MGB link, then 40 Mbps worth of traffic must be removed in order to meet the QoS requirements (0 packet loss) on the MGA to MGB link.

For ease of explanation, FIGS. 3-5 and the previous discussion have focused on the simplest network scenario. This simple case is quite a bit different than an actual network. A real-world network would have more than two Media Gateways. Also, the links in the IP network are not mutually independent. The IP links would carry packets from many MG-MG pairs. Therefore the above process would be applied to each transport link interconnecting MG-MG pairs. Taking the MG-MG routing into account, the MG-MG traffic should be mapped to transport links and the above process applied to each of the transport links. The MG-MG routing plan is generally referred to as the MG-to-MG route map. The transport link connectivity between MGs is generally referred to as the Transport Link map.

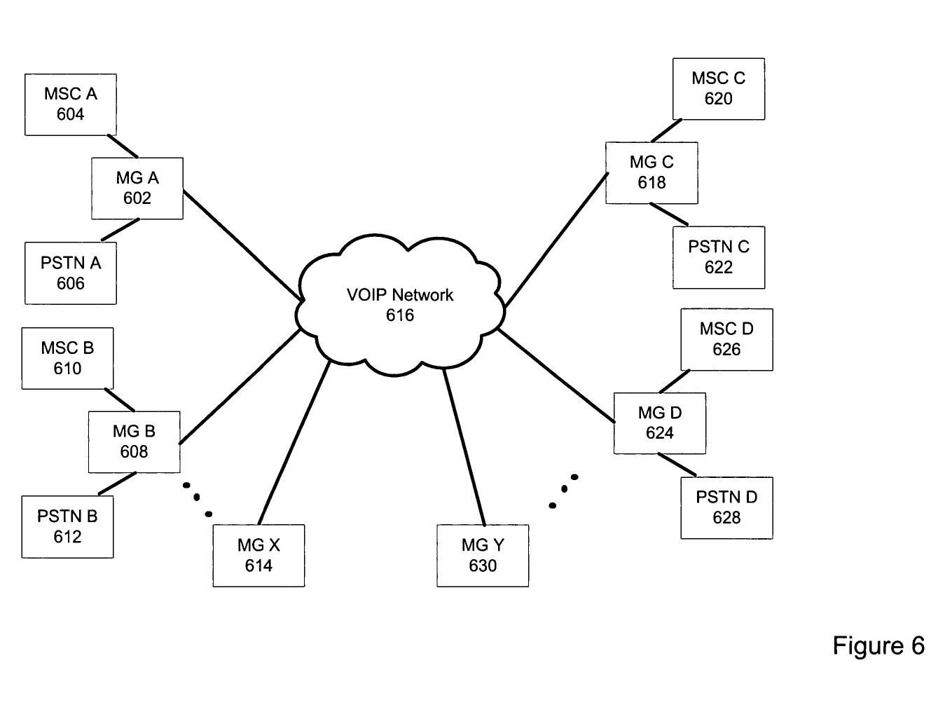

FIG. 6 shows a more complicated VoIP example. VoIP network 616 interconnects MGA 602, MGB 608, MGC 618, MGD 624, MGX 614, and MGY 630. MGX 614 and MGY 630 are generic descriptors to indicate that many more Media Gateways could be interconnected by the VoIP network 616. Each Media Gateway is connected to a MSC and a PSTN: MGA 602 is connected to MSCA 604 and PSTNA 606; MGB 608 is connected to MSCB 610 and PSTNB 612; MGC 618 is connected to MSCC 620 and PSTNC 622; MGD 624 is connected to MSCD 626 and PSTND 628. It is evident that calculating optimal routing decisions will quickly become difficult as the size of the network grows. In a complex network such as this, there are many MG-MG pairs, so the load between various MG pairs is represented as a load vector where a vector simply refers to an ordered sequence of numbers. Note that there are two types of load vectors: the offered load vector and the carried load vector. Similarly, instead of a single minimum bit rate for a link, there is a minimum bit rate vector representing the minimum bit rates required on the various links interconnecting the MGs.

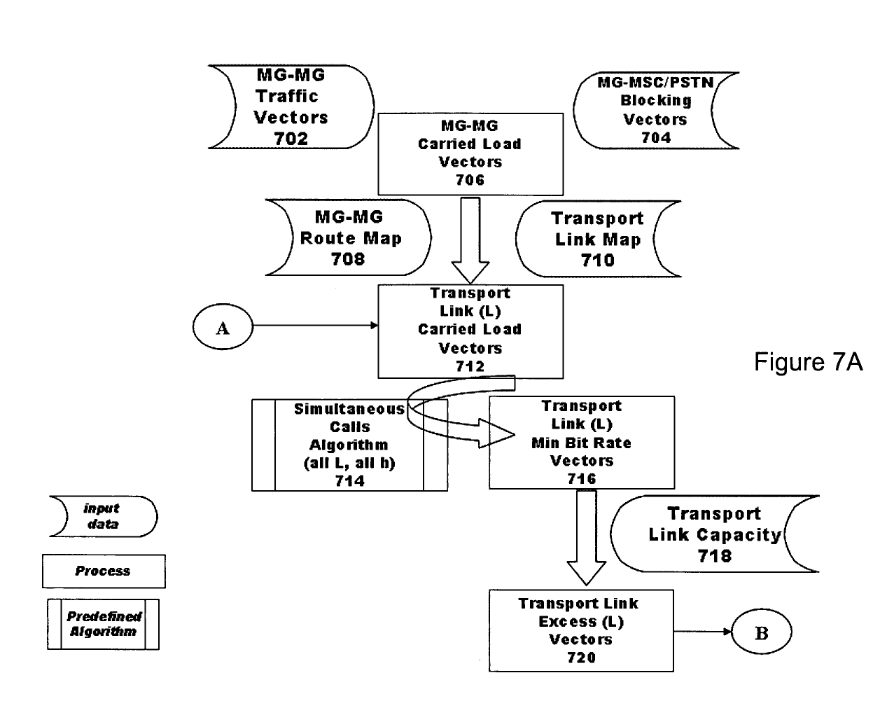

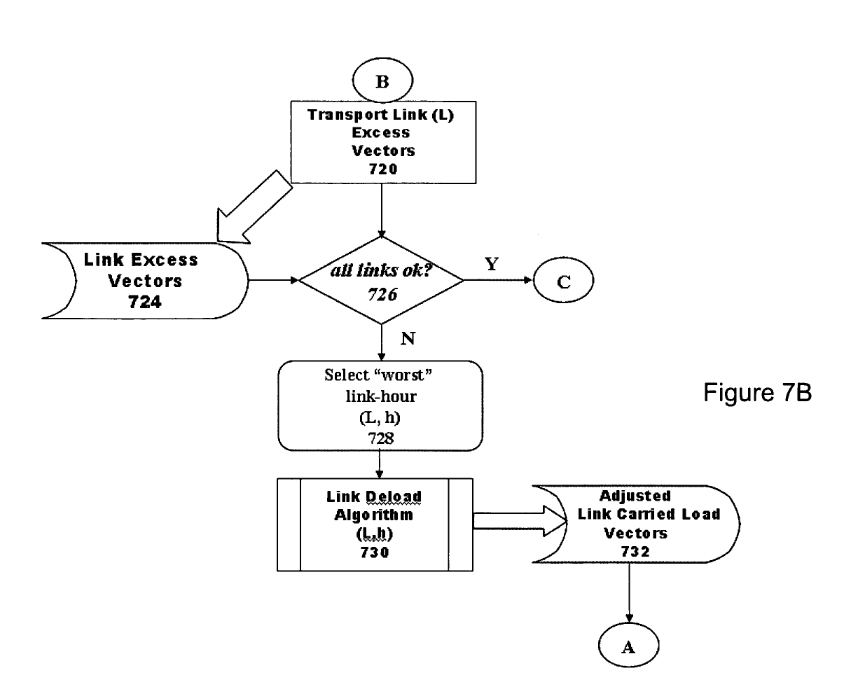

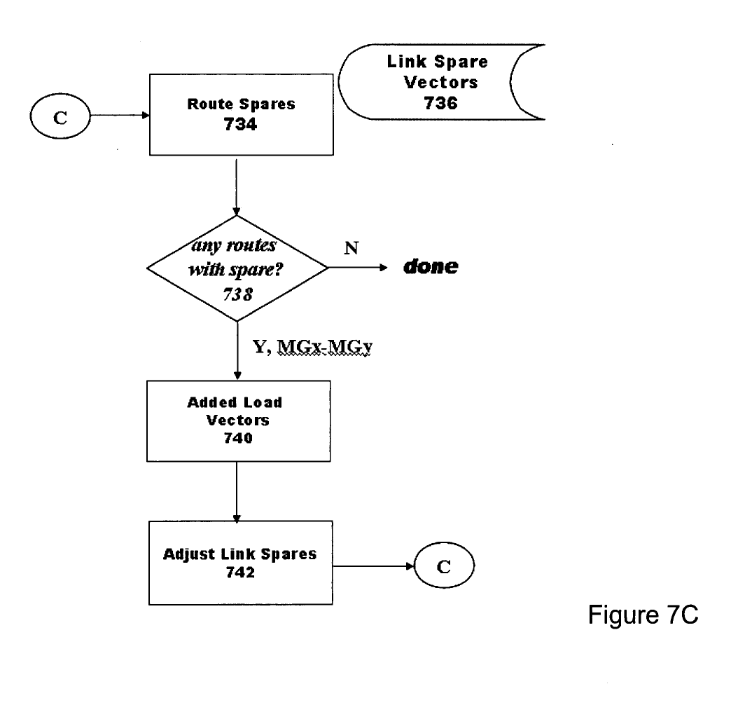

FIGS. 7A-C show an embodiment of a method of implementing the disclosed invention. The main steps in this are described below.

Some definitions of terms as used herein are as follows:

MGₘ: Switch-to-MG Homing, where m is Media Gateway (MG). MGₘ contains the set of all switches homing on media gateway m.

T_{d}: Trunk Size for each Terminating Switch, where d is terminating switch.

SA_{sdh}: Switch-to-Switch Offered Load in Erlangs, where s, d are originating and terminating switch, and h is hour of day.

C_{d}: Terminating Switch Tariff Cost, where d is terminating switch.

C′_{d}: Alternate Terminating Switch Tariff Cost, where d is terminating switch.

BW_{L}: Transport Link Capacity in Mbps, where L is transport link in the VoIP backbone network.

The steps below are described in conjunction with FIGS. 7A-C.

First, calculate MG-to-MG Carried Load Vector (MCₘₙₕ) 702:

Using Switch-to-Switch Offered Load (SA_{sdh}), the sum of all offered load, in Erlangs, can be calculated at any particular terminating switch. Then the inverse Erlang B formula is applied to actual trunk size T_{d} and the sum of the all offered load to obtain the blocking probability α_{dh} (where d is the terminating switch, and h is hour of the day) 704 for that particular terminating switch. Finally, the carried load for a terminating switch d spread across all originating switches at particular hour of the day is calculated as Switch-to-Switch Carried Load SC_{sdh}=SA_{sdh}×(1−α_{dh}).

With Switch-to-MG Homing vectors (MGₘ) and Switch-to-Switch Carried Load (SC_{sdh}), the MG-to-MG Carried Load (MCₘₙₕ) 706 can be calculated by summing over all originating switches that are homing to media gateway m and all terminating switches homing to media gateway n, i.e.
MCₙₘₕ=Σ_{(s on m,d on n)}(SC_{sdh})

This information is stored for each MG pair m,n as the MG-to-MG Carried Load Vector 706, for computational purposes.

Next, calculate Transport Link (L) Carried Load Vectors 712 in Erlangs:

Given the MG-MG route map 708 and the transport network link map 710 (topology) for the VoIP backbone network, the carried load for any transport link by summing all of MG-to-MG Carried Load (MCₘₙₕ) carried on this particular transport link is easily obtained, since it is simply the sum of all MG-MG carried load routed on a given link. This information is stored for all links for computational purposes as a Transport Link Carried Load Vector 712.

Next, calculate Transport Link (L) Minimum Bit Rate Vectors 716 in Mbps:

Based on codec used for VoIP backbone network, Quality of Service (QoS) requirements on the VoIP performance, and the carried load on link L, calculate hourly minimum IP bandwidth requirements for each transport link can be calculated and the worst-case scenario across all hours in the day can be found, using a simultaneous calls algorithm 714. This is then used as the minimum bit rate required for link L. This information is stored for all transport links as a Minimum Bit Rate Vector 716.

Next, find Transport Link (L) Excess Vectors 720 load as follows:

Based on Transport Link Capacity (BW_{L}) 718 and minimum bit rate required for the transport link, the transport link excess load (ΔBW_{L}) 720 is found. If excess load (ΔBW_{L}) 724 for all transport link in the VoIP network is less or equal to zero (726), then the traffic off-loading process is done, and the method proceeds to the Route Spares step 734, otherwise it goes to 728. For computational convenience, the transport link excess load for each link is stored in the form of a vector.

Next, find Traffic to be Off-loaded between Switches 730:

Based on MG-to-MG Routing Map 708, all MG-MG pairs with traffic routed on the transport link which has exceeded its link capacity can be found, and is referred to herein as a violating link. For each MG-MG pair using the violating link their associated originating and terminating switches can be easily found.

The terminating switches (Dⱼ) should then be sorted in descending order of additional cost incurred by off-loading the traffic to the other carrier network (C_{d}-C_{d}′, where C_{d} is Terminating Switch Tariff Cost, and C_{d}′ is Alternate Terminating Switch Tariff Cost).

Starting with the first terminating switch, for each terminating switch d in Dⱼ, if sum of all the traffic (A) carried by the violating transport link L and terminating at that switch is less than or equal to the transport link excess vector (ΔBW_{L}), then all of this traffic should be off-loaded, and ΔBW_{L} updated to reflect the fact that this traffic is no longer carried by the VoIP network. This is continued until the sum of all the traffic (A) for terminating switch d is greater than the transport link excess load (ΔBW_{L}). When this happens, the entire traffic terminating on switch d should not be off-loaded as there is capacity on link L to carry a portion of the traffic. So the source switches sending traffic to terminating switch d via link L are used to determine the traffic to be off-loaded, as follows. Let S be the set of all source switches Sᵢ that send traffic to terminating switch d via link L. The switches Sᵢ are sorted in ascending order of the total traffic sent to terminating switch d. Then starting with the first switch in the sorted list, all the traffic to is off-loaded d as long as the traffic volume is less than or equal to the remaining transport link excess load (ΔBW_{L}), and ΔBW_{L} is updated to reflect the traffic no longer carried by the VoIP network. This is repeated until ΔBW_{L} is less than or equal to zero.

Once the traffic to be off-loaded between switches is identified 730, Switch-to-Switch Carried Load Vector (SC_{sd}) 732 is updated to reflect the fact that this traffic is no longer carried by the VoIP backbone network. The method proceeds to 716.

Next, Add Traffic back to VoIP Network 734:

After off-loading traffic as outlined in the steps above 730, it is possible that some transport links may have some spare capacity left. This step examines how to add traffic back to links with spare capacity in order to improve the overall utilization of the carrier's owned network. Using Transport Link Capacity (BW_{L}) and minimum bit rate required for the transport link, the transport link spare capacity can be found. For computational convenience, the transport link spare capacity for each link is stored in the form of a vector 736.

Let Tᵢⱼ be the traffic from source switch Sᵢ to terminating switch Dⱼ that was off-loaded due to QoS requirements on the VoIP backbone network Let T be the set of all Tᵢⱼ. The traffic set T should be sorted in descending order in terms of traffic volume. Then starting with the first item in the sorted list each item is added back to VoIP network according to MG-to-MG routing information. If the spare capacity of any transport link used by this traffic 738 is less than this traffic amount, then this traffic cannot be carried and must be ignored. Otherwise, 740 the traffic will be added back to the network (i.e. re-carried by the VoIP network) and the link spare will be updated 742 for all links used by the traffic. This continues until either all traffic in the sorted list T are examined or none of transport links in the network has any spare capacity.

One embodiment of the present invention includes a method for routing network traffic, the method comprising creating a plurality of Call Detail Records, each Call Detail Record correlating with a transmission from an origination point to a termination point, extracting call data from the plurality of Call Detail Records, analyzing the call data to prioritize network traffic; and optimizing traffic hand-off between a first network and a second network based on the prioritized traffic.

Another embodiment of the present invention includes a method for improving network efficiency, the method comprising determining wireless switch-to-switch offered load, determining an available IP bandwidth between a first media gateway and a second media gateway, determining a trunk size for at least one terminating switch, calculating carried traffic to be off-loaded between the first and the second media gateway, locating traffic to be off-loaded between a plurality of switches, re-evaluating the carried traffic between the first and second media gateway, re-evaluating the carried load between at least one switch and the first media gateway; and adding back traffic between the first and the second media gateway.

Another embodiment of the present invention includes a data processing system for routing network traffic, the system comprising means for creating a plurality of Call Detail Records, each Call Detail Record correlating with a transmission from an origination point to a termination point, means for extracting call data from the plurality of Call Detail Records, means for analyzing the call data to prioritize network traffic; and means for optimizing traffic hand-off between a first network and a second network based on the prioritized traffic. These means can be implemented using known data processing components, network analysis tools, and telecommunications hardware, as those of skill in the art will recognize.

Another embodiment of the present invention includes a data processing system for improving network efficiency, the system comprising means for determining wireless switch-to-switch offered load, means for determining an available IP bandwidth between a first media gateway and a second media gateway, means for determining a trunk size for at least one terminating switch, means for calculating carried traffic to be off-loaded between the first and the second media gateway, means for locating traffic to be off-loaded between a plurality of switches, re-evaluating the carried traffic between the first and second media gateway, means for re-evaluating the carried load between at least one switch and the first media gateway; and means for adding back traffic between the first and the second media gateway. These means can be implemented using known data processing components, network analysis tools, and telecommunications hardware, as those of skill in the art will recognize.

Aspects of the invention described above may be stored or distributed on computer-readable media, including magnetic and optically readable and removable computer discs, as well as distributed electronically over the Internet or over other networks (including wireless networks). Those skilled in the relevant art will recognize that portions or embodiments of the invention may reside in a fixed element of a communication network, while corresponding portions may reside on a mobile communication device. Data structures and transmission of data particular to aspects of the invention are also encompassed within the scope of the invention.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

The above detailed descriptions of embodiments of the invention are not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. Although embodiments of the invention have been described primarily in the context of wireless networks, the teachings of the invention provided herein can be applied to many other types of networks and network operators. Embodiments of the invention could be applied to any sort of network where the network operator must off-load some traffic onto another operator's network. For example, those skilled in the art could apply the teachings of the invention to an Internet Service Provider (ISP) network.

Although embodiments of the invention are described with a VoIP network, those skilled in the art understand that many equivalent packet schemes are suitable, such as Voice over Frame Relay (VoFR), Voice over Asynchronous Transfer Mode (VoATM), Voice over Cable (VoC), Voice and Fax over Internet Protocol (V/FoIP), or Voice over Digital Subscriber Line (VoDSL). These and other changes can be made to the invention in light of the detailed description.

Aspects of the invention can be modified, if necessary, to employ the systems, functions and concepts of the various references described above to provide yet further embodiments of the invention.

These and other changes can be made to the invention in light of the above detailed description. In general, the terms used in the following claims should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

The headings provided herein are for convenience only and do not necessarily affect the scope or meaning of the claimed invention.

In view of the many possible embodiments to which the principles of this invention may be applied, it should be recognized that the detailed embodiments are illustrative only and should not be taken as limiting the scope of the invention. Rather, I claim as my invention all such embodiments as may come within the scope and spirit of the following claims and equivalents thereto.

It is important to note that while the present invention has been described in the context of a fully functional system, those skilled in the art will appreciate that at least portions of the mechanism of the present invention are capable of being distributed in the form of a instructions contained within a machine usable medium in any of a variety of forms, and that the present invention applies equally regardless of the particular type of instruction or signal bearing medium utilized to actually carry out the distribution. Examples of machine usable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDS), and transmission type mediums such as digital and analog communication links.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

1. A method for routing network traffic, the method comprising:
creating a plurality of call detail records, each call detail record correlating with a transmission from an origination point to a termination point;
extracting call data from the plurality of call detail records;
analyzing the call data to prioritize network traffic; and
optimizing traffic hand-off between a first network and a second network based on the prioritized traffic.

2. The method of claim 1, further comprising moving at least some network traffic from the first network to the second network.

3. The method of claim 1, further comprising evaluating network traffic capacity of the first network and the second network.

4. The method of claim 1, further comprising determining a route map from the origination point to the termination point.

5. The method of claim 1, wherein the second network is a packet-based network.

6. A method for improving network efficiency, the method comprising:
determining wireless switch-to-switch offered load;
determining an available IP bandwidth between a first media gateway and a second media gateway;
determining a trunk size for at least one terminating switch;
calculating carried traffic to be off-loaded between the first and the second media gateway;
locating traffic to be off-loaded between a plurality of switches;
re-evaluating the carried traffic between the first and second media gateway;
re-evaluating the carried load between at least one switch and the first media gateway; and
adding back traffic between the first and the second media gateway.

7. The method of claim 6, wherein re-evaluating the carried load between the at least one switch and the first media gateway includes evaluating quality-of-service of carried traffic between the at least one switch and the first media gateway.

8. The method of claim 6, wherein re-evaluating the carried load between the first and second media gateway includes evaluating quality-of-service of carried traffic between the first and second media gateway.

9. The method of claim 6, further comprising determining transport link capacity.

10. The method of claim 1, further comprising determining a period of greatest carried traffic.

11. A system for routing network traffic, the system comprising:
means for creating a plurality of call data records, each call data record correlating with a transmission from an origination point to a termination point;
means for extracting call data from the plurality of call data records;
means for analyzing the call data to prioritize network traffic; and
means for optimizing traffic hand-off between a first network and a second network based on the prioritized traffic.

12. The system of claim 11, further comprising means for moving at least some network traffic from the first network to the second network.

13. The system of claim 11, further comprising means for evaluating network traffic capacity of the first network and the second network.

14. The system of claim 11, further comprising means for determining a route map from the origination point to the termination point.

15. The system of claim 11, wherein the second network is a packet-based network.
